(19) United States
(12) Patent Application Publication
(10) Pub. No.: US 2025/0167669 A1
(43) Pub. Date: May 22, 2025

(54) ELECTRONIC DEVICE INCLUDING CHARGING CIRCUIT AND OPERATING METHOD OF ELECTRONIC DEVICE

(71) Applicant: SAMSUNG ELECTRONICS CO., LTD., Suwon-si (KR)

(72) Inventors: Chiun-He LIN, Zhubei City (TW); Minyong JUNG, Suwon-si (KR); Chen TSOU, Zhubei City (TW)

(73) Assignee: SAMSUNG ELECTRONICS CO., LTD., Suwon-si (KR)

(21) Appl. No.: 19/024,988

(22) Filed: Jan. 16, 2025

(30) Foreign Application Priority Data
Nov. 21, 2023 (KR) 10-2023-0162717

(51) Int. Cl. H02M 1/38; H02M 1/00; H02M 7/219

(52) U.S. Cl. CPC H02M 1/38; H02M 1/0016; H02M 7/219

(57) ABSTRACT

Provided is an electronic device including an inductor configured to be charged, a distribution circuit configured to charge the inductor for a first period, provide a first output voltage to outside through a first output terminal, based on the charged inductor, charge the inductor for a second period, and provide a second output voltage to the outside through a second output terminal, based on the charged inductor, and a timing controller configured to alternately provide the first output voltage and the second output voltage in the first period and the second period and provide a control signal to the distribution circuit such that at least some of a plurality of first periods are consecutive.

### CROSS-REFERENCE TO RELATED APPLICATION

This application is based on and claims priority under 35 U.S.C. § 119 to Korean Patent Application No. 10-2023-0162717, filed on Nov. 21, 2023, in the Korean Intellectual Property Office, the disclosure of which is incorporated by reference herein in its entirety.

### BACKGROUND

The disclosure relates to a charging circuit, and more particularly, to a charging circuit, which includes a switching converter having an output inverted by using a single inductor, and an operating method of the charging circuit.

Switching converters may be used to generate supply voltages to provide power to various electric components (may also be referred to as loads), due to high power efficiency, and the loads may operate by consuming load currents provided by the switching converters. Loads may require various supply voltages, and accordingly, a plurality of switching converters may respectively generate a plurality of supply voltages from a same input voltage.

When loads require negative voltages, short-through may occur between outputs as negative voltages are output, and as a plurality of supply voltages are repeatedly supplied to the loads, and energy consumption for switching may increase. Accordingly, there is a need to prevent short-through and reduce energy consumption for switching.

### SUMMARY

One or more aspects of the disclosure provide an electronic device configured to provide an output inverted from an input voltage to a plurality of external devices by using a single inductor, prevent short through, and improve energy efficiency, and a method of operating the electronic device.

Embodiments of the disclosure are not limited to the aforementioned technical goals, and other technical goals and/or other aspects not mentioned above may be clearly understood to those skilled in the art from the following descriptions.

According to an aspect of the disclosure, there is provided an electronic device including: an inductor configured to be charged based on an input voltage provided from a voltage source; a distribution circuit configured to: charge the inductor during a plurality of first periods, and provide a first output voltage based on the input voltage, to outside through a first output terminal, based on the inductor that is charged, and charge the inductor during a plurality of second periods, and provide a second output voltage based on the input voltage, to the outside through a second output terminal, based on the inductor that is charged; and a timing controller configured to: alternately provide the first output voltage and the second output voltage in the plurality of first periods and the plurality of second periods, and provide a control signal to the distribution circuit such that at least some of the plurality of first periods are consecutive, wherein the distribution circuit includes: a first transistor and a second transistor, wherein a first terminal of the first transistor is connected to the inductor, a second terminal of the first transistor is connected to a first terminal of the second transistor, and a second terminal of the second transistor is connected to the first output terminal.

According to an aspect of the disclosure, there is provided an operating method of an electronic device, the method including: charging an inductor, based on an input voltage provided from a voltage source, during a first first period being first in sequence among a plurality of first periods, and providing, based on the inductor charged during the first first period, a first output voltage corresponding to the input voltage to outside through a first output terminal; charging the inductor, based on the input voltage, for a second first period being second in sequence consecutive to the first first period among a plurality of first periods, and providing, based on the inductor charged during the second first period, the first output voltage corresponding to the input voltage to the outside through the first output terminal; charging the inductor, based on the input voltage, for a second period and providing, based on the inductor charged during the second period, a second output voltage corresponding to the input voltage to the outside through a second output terminal, wherein each of the plurality of first periods includes a first charge period to charge the inductor and a first discharge period to provide the first output voltage to the outside, and wherein a first transistor is in a turned-on state from a first first discharge period of the first first period to a second first discharge period of the second first period, a first terminal of the first transistor is connected to the inductor, a second terminal of the first transistor is connected to a first terminal of a second transistor, and a second terminal of a second transistor is connected to the first output terminal.

According to an aspect of the disclosure, there is provided an electronic device including: an inductor configured to be charged based on an input voltage provided from a voltage source; a distribution circuit configured to: charge the inductor during a plurality of first periods, and provide a first output voltage based on the input voltage, to outside through a first output terminal, based on the inductor that is charged, and charge the inductor during a plurality of second periods, and provide a second output voltage based on the input voltage, to the outside through a second output terminal, based on the inductor that is charged; and a timing controller configured to provide a control signal to the distribution circuit such that plurality of first periods and the plurality of second periods are repeated and the first output voltage and the second output voltage are repeatedly provided in a time-division manner, wherein the distribution circuit includes: a first transistor and a second transistor, which are connected in series between the inductor and the first output terminal, and a third transistor and a fourth transistor connected in series between the inductor and the second output terminal.

### BRIEF DESCRIPTION OF DRAWINGS

Embodiments will be more clearly understood from the following detailed description taken in conjunction with the accompanying drawings in which:

FIG. 1 is a block diagram of an electronic device according to an embodiment;

FIG. 2 is a block diagram of a distribution circuit according to an embodiment;

FIGS. 3A, 3B, and 3C are block diagrams illustrating operations of a distribution circuit according to an embodiment;

FIG. 4 is a timing chart of control signals and an inductor current, according to an embodiment;

FIG. 5 is a timing chart of control signals and an inductor current, according to an embodiment;

FIG. 6 is a timing chart of control signals and an inductor current, according to an embodiment;

FIG. 7 is a block diagram of a distribution circuit according to an embodiment;

FIG. 8 is a block diagram of a distribution circuit according to an embodiment;

FIG. 9 is a flowchart illustrating operations of an electronic device including a distribution circuit according to an embodiment; and

FIG. 10 is a block diagram of an electronic device according to an embodiment.

### DETAILED DESCRIPTION

Hereinafter, one or more embodiments will be described in detail with reference to embodiments.

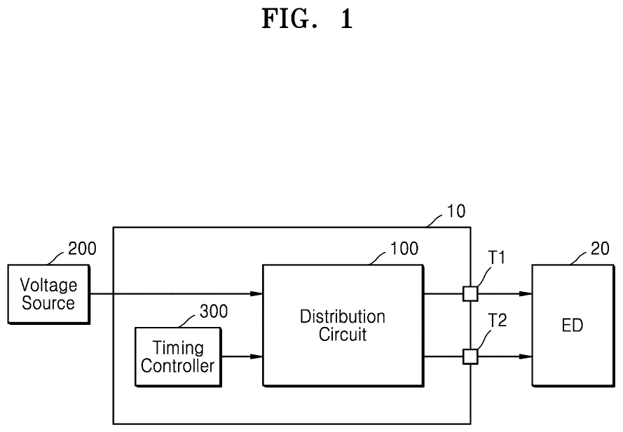

FIG. 1 is a block diagram of an electronic device 10 according to an embodiment.

FIG. 1 also illustrates an external device (ED) 20 and a voltage source 200 connected to the electronic device 10.

Referring to FIG. 1, the electronic device 10 may include a distribution circuit 100 and a timing controller 300. However, disclosure is not limited thereto, and as such, according to an embodiment, the electronic device 10 may further include one or more other components. For example, the electronic device 10 may include, but is not limited to, processors, communication circuits, display units, and the like. The electronic device 10 may include other general-purpose components.

The electronic device 10 according to embodiments may be configured to provide a voltage to the ED 20 based on a voltage provided from the voltage source 200. For example, the electronic device 10 according to an embodiment of the disclosure may be configured to provide a first output voltage and a second output voltage to the ED 20. The voltage source 200 according to an embodiment of the disclosure may include an external device configured to provide a voltage to the electronic device 10. The electronic device 10 may further include a power interface configured to receive the voltage provided from the voltage source 200. For convenience of explanation, it is described that the voltage source 200 is outside the electronic device 10, but an embodiment of the disclosure is not limited thereto, and the voltage source 200 may be in the electronic device 10. For example, the voltage source 200 may include a battery included in the electronic device 10. Hereinafter, the voltage provided from the voltage source 200 to the electronic device 10 is referred to as an output voltage.

According to an embodiment, based on the input voltage, the distribution circuit 100 may be configured to generate output voltages provided to the ED 20. For example, based on the input voltage, the distribution circuit 100 may be configured to generate a first output voltage and a second output voltage. The ED 20 may be connected to the electronic device 10 through a first output terminal T1 and a second output terminal T2. According to an embodiment, the first output voltage may be provided to the ED 20 through the first output terminal T1 and the second output voltage may be provided to the ED 20 through the second output terminal T2. For convenience of explanation, it is described that the electronic device 10 is connected to one ED 20 and is configured to provide the first output voltage and the second output voltage to the ED 20. However, the disclosure is not limited thereto. For example, the electronic device 10 according to an embodiment of the disclosure may be connected to a first external device and a second external device, respectively through the first output terminal T1 and the second output terminal T2, and may be configured to provide the first output voltage and the second output voltage, respectively to the first external device and the second external device, through the first output terminal T1 and the second output terminal T2. The ED 20 according to an embodiment of the disclosure may include a device to which a negative voltage is provided. For example, the ED 20 may include a display panel.

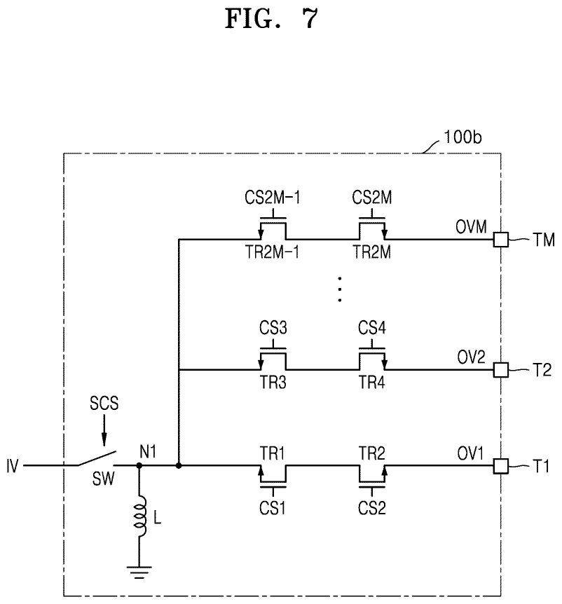

Hereinafter, an example in which the distribution circuit 100 generates charge voltages (e.g., the first output voltage and the second output voltage) provided to the ED 20 based on the input voltage, will be described. However, the distribution circuit 100 is not limited thereto, and may generate three or more charge voltages through three or more output voltages, respectively, and provide the charge voltages to the ED 20, as illustrated in FIG. 7. In addition, as described above, the electronic device 10 may be configured to provide output voltages respectively to three or more different external devices through the three or more output terminals.

The distribution circuit 100 may be configured generate output voltages provided to the ED 20 based on an input voltage provided from the voltage source 200. For example, the distribution circuit 100 may be configured to buck or boost the input voltage and generate the first output voltage and the second output voltage provided to the ED 20 through the first output terminal T1 and the second output terminal T2.

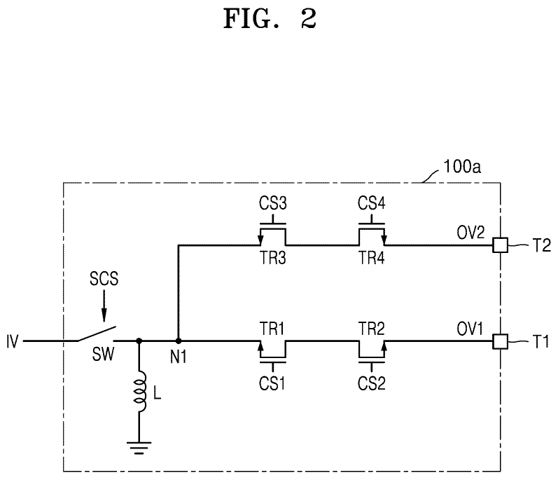

In some embodiments, the distribution circuit 100 may include an inverting converter having a single inverter and multiple outputs as described below with reference to FIGS. 2 to 8. However, the disclosure is not limited thereto, and as such, according to another embodiment, the distribution circuit 100 may include an inverting converter having another configuration. The inverting converter may be configured to perform a buck-boost operation, based on the input voltage provided from the voltage source 200, and generate the first output voltage and the second output voltage provided to the ED 20. Hereinafter, the first output voltage and the second output voltage may be correspond to voltages inverted from the input voltage.

The distribution circuit 100 may be configured to alternately generate the first output voltage and the second output voltage by using the single inductor. Accordingly, the distribution circuit 100 may be configured to generate the first output voltage and the second output voltage regardless of a voltage level of the input voltage provided from the voltage source 200. For example, the distribution circuit 100 may be configured to provide the first output voltage and the second output voltage, which are different from each other, to the ED 20 through the first output terminal T1 and the second output terminal T2.

As described above, the distribution circuit 100 according to an embodiment of the disclosure may be configured to provide the first output voltage and the second output voltage to the ED, alternately through the first output terminal T1 and the second output terminal T2. That is, at a certain time point, only any one of the first output voltage and the second output voltage may be provided to the ED 20. The distribution circuit 100 according to an embodiment of the disclosure may include at least two transistors connected in series between an inductor and an output voltage (e.g., the first output voltage terminal T1 or the second output voltage terminal T2). The first output voltage and the second output voltage, which are provided by the distribution circuit 100 to the ED 20 through the first output terminal T1 and the second output terminal T2, may each include a negative voltage. In an example case in which there is only one transistor between the inductor and the second output terminal T2, a current may flow from the second output terminal T2 in a direction of the inductor due to a parasitic diode included in the transistor. According to an embodiment of the disclosure, the distribution circuit 100 may be configured to prevent the current flowing from the second output terminal T2 in the direction of the inductor, based on at least two transistors connected in series between the second output terminal T2 and the inductor. Accordingly, while minimizing bills of material (BOM) and printed circuit boards (PCB) required to provide a negative voltage to the ED 20, energy efficiency of the distribution circuit 100 may be improved by controlling operations of transistors connected in series like in the following description. A configuration and operations of the distribution circuit 100 will be described in detail with reference to FIGS. 2 to 8.

The timing controller 300 may generate a plurality of control signals to control one or more operations of the distribution circuit 100. For example, the timing controller 300 may control two transistors, which are connected in series, and may provide the plurality of control signals respectively to the two transistors. The timing controller 300 may be configured to generate the plurality of control signals and provide the plurality of control signals to the distribution circuit 100 such that the distribution circuit 100 performs operations described below.

The distribution circuit 100 may be implemented in various forms. For example, the distribution circuit 100 may be implemented as one or more semiconductor devices. For example, the one or more semiconductor devices may include, but is not limited to, a semiconductor chip, a semiconductor package, and the like. In some embodiments, the distribution circuit 100 may be mounted on a board (e.g., a PCB) in the electronic device 10, and one or more circuit elements related to a charge operation may be arranged on the board, and the distribution circuit 100 may be connected to the one or more circuit elements. The one or more circuit elements may include, but is not limited to, an inductor, a capacitor, etc. In some embodiments, the distribution circuit 10 may be formed as a semiconductor chip, in which some or all circuits are formed, and a passive element, the semiconductor chip and the passive element may be arranged on the board in the electronic device 10, and the semiconductor chip and the passive element may be electrically connected to each other. The passive element may include, but is not limited to, an inductor.

According to an embodiment, a power interface may be between the voltage source 200 and the electronic device 10. The power interface may include a wired power receiving circuit and/or a wireless power receiving circuit. For example, the wired power receiving circuit and/or a wireless power receiving circuit may include a rectifier, a regulator, and the like.

FIG. 2 is a block diagram of a distribution circuit 100a according to an embodiment.

Referring to FIG. 2, the distribution circuit 100a may include a switch SW, a first transistor TR1, a second transistor TR2, a third transistor TR3, a fourth transistor TR4, an inductor L, the first output terminal T1, and the second output terminal T2. The distribution circuit 100a may correspond to the distribution circuit 100 described with reference to FIG. 1, and same descriptions will not be repeatedly given. Moreover, the distribution circuit 100a may be connected to a voltage source 200, a timing controller 300 and an external device (ED) 20 as described with reference to FIG. 1, and same descriptions will not be repeatedly given.

Referring to FIGS. 1 and 2, the distribution circuit 100a may be configured to receive an input voltage IV from the voltage source 200. The timing controller 300 according to an embodiment of the disclosure may be configured to generate control signals. The control signals may include a switch control signal SCS, a first control signal CS1, a second control signal CS2, a third control signal CS3, and a fourth control signal CS4. The timing controller 300 may be configured to generate and provide the switch control signal SCS, the first control signal CS1, the second control signal CS2, the third control signal CS3, and the fourth control signal CS4 to control operations of the switch SW, the first transistor TR1, the second transistor TR2, the third transistor TR3, and the fourth transistor TR4 included in the distribution circuit 100a. For example, the timing controller 300 may be configured to generate the switch control signal SCS and provide the switch control signal SCS to the switch SW to control operations of the switch SW. Also, the timing controller 300 may be configured to generate and provide the first control signal CS1 to control operations of the first transistor TR1, the second control signal CS2 to control operations of the second transistor TR2, the third control signal CS3 to control operations of the third transistor TR3, and the fourth control signal CS4 to control operations of the fourth transistor TR4 included in the distribution circuit 100a. The switch SW may connect the inductor L to the voltage source 200 configured to provide the input voltage IV based on the switch control signal SCS having logic-high. According to an embodiment, a logic-high level may be referred to as an active level and a logic-low level may be referred to as an inactive level. Through the embodiments described above, operations of the first transistor TR1, the second transistor TR2, the third transistor TR3, and the fourth transistor TR4 based on the first control signal CS1, the second control signal CS2, the third control signal CS3, and the fourth control signal CS4 generated and provided by the timing controller 300 may be understood.

Referring to FIG. 2, the switch SW included in the distribution circuit 100a may be connected to a terminal, which receives the input voltage IV, and a first node N1. As the switch SW is turned on based on the switch control signal SCS having the active level, the input voltage IV may be applied to the first node N1. The switch SW may include a NMOS transistor. However, the disclosure is not limited thereto, and as such, another type of switch may be provided as switch SW.

The distribution circuit 100a may be implemented as a buck-boost converter including a single inductor L. The distribution circuit 100a may be configured to generate a first output OV1 and a second output voltage OV2 by performing a buck-boost operation using the single inductor L.

The inductor L included in the distribution circuit 100a may be connected between a ground voltage and the first node N1. In an example case in which the switch SW is turned on, the inductor L may be charged based on the input voltage IV applied to the first node N1. In an example case in which the switch SW is turned off based on the switch control signal SCS having an inactive level (or a logic-low level), the inductor L may discharge a voltage to the first node N1 based on the charged voltage. For example, the distribution circuit 100a may alternately generate the first output voltage OV1 and the second output voltage OV2 by bucking or boosting the input voltage IV based on the inductor L. The distribution circuit 100a may be configured to provide the first output voltage OV1 and the second output voltage OV2 to the external device (for example, ED20 of FIG. 1) through the first output terminal T1 and the second output terminal T2. Accordingly, the distribution circuit 100a may be configured to independently control the first output voltage OV1 and the second output voltage OV2 provided to the external device.

The first output voltage OV1 may be different from the second output voltage OV2. For example, the distribution circuit 100a may be configured to generate the first output voltage OV1 to be higher than the input voltage IV by boosting the input voltage IV, generate the second output voltage OV2 to be lower than the input voltage IV by bucking the input voltage IV, and provide the first output voltage OV1 and the second output voltage OV2 to the external device. However, the disclosure is not limited thereto. As such, according to another embodiment, the first output voltage OV1 and the second output voltage OV2 requested by or required for the external device may be identical to each other, and the distribution circuit 100a may be configured to generate the first output voltage OV1 and the second output voltage OV2, which have a same voltage level, and provide the first output voltage OV1 and the second output voltage OV2 to the external device.

The distribution circuit 100a may be configured to generate the first output voltage OV1 and the second output voltage OV2 based on the input voltage IV by adjusting a time period to charge/discharge the inductor L with a voltage. In other words, in the distribution circuit 100a, the turn-on times and the turn-off times of the first transistor TR1, the second transistor TR2, the third transistor TR3, and the fourth transistor TR4 may be adjusted such that the first output voltage OV1 and the second output voltage OV2 are generated. For example, the duty ratios of the first transistor TR1, the second transistor TR2, the third transistor TR3, and the fourth transistor TR4 may be adjusted to generate the first output voltage OV1 and the second output voltage OV2.

The first output voltage OV1 and the second output voltage OV2 may correspond to voltages inverted from the input voltage IV. In an example case in which the input voltage IV includes a positive voltage, each of the first output voltage OV1 and the second output voltage OV2 may include a negative voltage.

The first transistor TR1 and the second transistor TR2 may be connected between the first output terminal T1 and the first node N1. The first transistor TR1 and the second transistor TR2 may be connected in series. A first terminal of the first transistor TR1 may be connected to the inductor L, and a second terminal of the first transistor TR1 may be connected to a first terminal of the second transistor TR2. A second terminal of the second transistor TR2 may be connected to the first output terminal T1.

The distribution circuit 100a may be configured to prevent short-through by including the first transistor TR1. The distribution circuit 100a may be configured to provide the second output voltage OV2 to the external device through the second output terminal T2. In this case, the timing controller 300 may be configured to generate the third control signal CS3 and the fourth control signal CS4 having an active level to provide the second output voltage OV2 to the external device through the second output terminal T2. In addition, the timing controller 300 may be configured to generate the switch control signal SCS having the inactive level. The third transistor TR3 and the fourth transistor TR4 may be respectively turned on based on the third control signal CS3 and the fourth control signal CS4 having an inactive level. In addition, the switch SW may be turned off based on the switch control signal SCS having the inactive level. Therefore, a second output terminal T2 and the first node N1 may be connected to each other, and a negative voltage corresponding to the second output voltage OV2 may be applied to the first node N1.

In an example case in which the first transistor TR1 is not provided, the first node N1 and the first output terminal T1 may be connected to each other by a parasitic diode included in the second transistor TR2 even when the second transistor TR2 is turned off. In an example case in which the second transistor TR2 includes an NMOS transistor, a parasitic diode capable of having a current flow from a body to a drain of the second transistor TR2 between the drain and the body. Accordingly, even when the second transistor TR2 is turned off, the first node N1 and the first output terminal T1 may be connected through the parasitic diode. That is, when the second output voltage OV2 is provided through the second output terminal T2, the first output terminal T1 and the second output terminal T2 may be connected through the first node N1, and therefore, a short-through may occur between the output voltages.

The distribution circuit 100a according to an embodiment of the disclosure includes the first transistor TR1, and thus may prevent short-through that may occur, according to the descriptions above. For example, the distribution circuit 100a may be configured to turn off the first transistor TR1 and prevent short-through while providing the second output voltage OV2 to the external device through the second output terminal T2.

The third transistor TR3 and the fourth transistor TR4 may be connected between the second output terminal T2 and the first node N1. The third transistor TR3 and the fourth transistor TR4 may be connected in series. A first terminal of the third transistor TR3 may be connected to the inductor L, and a second terminal of the third transistor TR3 may be connected to a first terminal of the fourth transistor TR4. A second terminal of the fourth transistor TR4 may be connected to the second output terminal T2.

Similar to the descriptions above, the distribution circuit 100a according to an embodiment of the disclosure may prevent short-through by including the third transistor TR3. For example, the distribution circuit 100a may be configured to turn off the third transistor TR3 and prevent short-through while providing the first output voltage OV1 to the external device through the first output terminal T1.

As described above, according to the distribution circuit 100a according to an embodiment of the disclosure, short-through may be prevented by connecting the first transistor TR1 between the first node N1 and the first output terminal T1 and connecting the third transistor TR3 between the first node N1 and the second output terminal T2. Accordingly, by not additionally including inductors and/or capacitors to prevent short-through, regions of BOM and PCB may be reduced as much as possible.

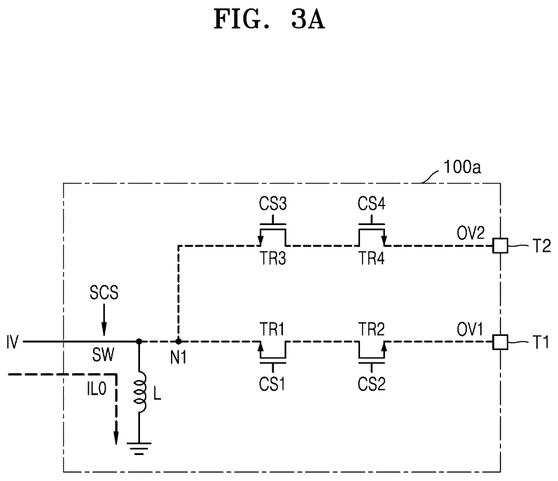

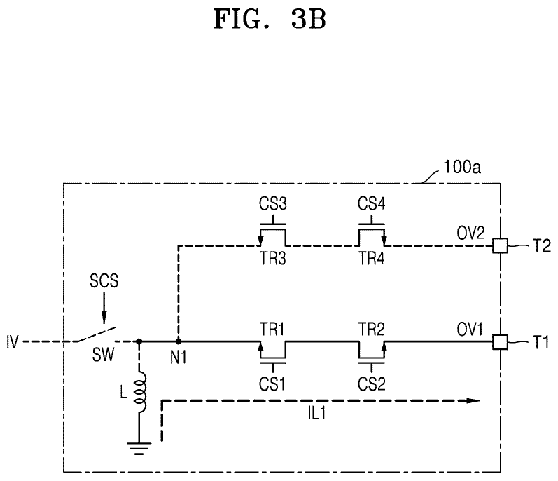

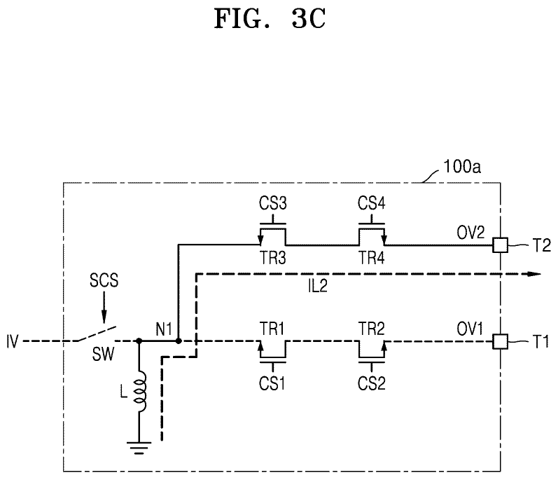

FIGS. 3A, 3B, and 3C are block diagrams illustrating operations of the distribution circuit 100a according to an embodiment.

FIGS. 3A, 3B, and 3C illustrate operations of the distribution circuit 100a described with reference to FIG. 2. Therefore, descriptions with reference to FIG. 2 may be applied to the distribution circuit 100a described with reference to FIGS. 3A, 3B, and 3C.

FIG. 3A illustrates an operation of the distribution circuit 100a to charge the inductor L. To charge the inductor L, the timing controller 300 may be configured to turn on the switch SW by providing the switch control signal SCS having the active level to the switch SW. The timing controller 300 may be configured to turn off the first transistor TR1, the second transistor TR2, the third transistor TR3, and the fourth transistor TR3 by providing the first control signal CS1, the second control signal CS2, the third control signal CS4, and the fourth signal CS4, which have an inactive level, respectively to the first transistor T1, the second transistor T2, the third transistor TR3, and the fourth transistor T4.

Accordingly, an inductor current IL0 flowing through the inductor L may flow from the first node N1 to the ground voltage. For example, the inductor current IL0 may be generated in the inductor L based on the input voltage IV provided from the voltage source 200, and the inductor L may be charged based on the inductor current IL0. The inductor current IL0 may increase due to the input voltage IV. In other words, the distribution circuit 100a may be configured to charge the inductor L based on the input voltage IV applied to the first node N1 by the voltage source 200.

FIG. 3B illustrates an operation of the distribution circuit 100a to provide the first output voltage OV1 to the external device based on the inductor L that has been charged. The timing controller 300 may be configured to generate and provide the switch control signal SCS, the third control signal CS3, and the fourth control signal CS4 having an inactive level to generate the first output voltage OV1 based on the inductor L that has been charged. Accordingly, the switch SW, the third transistor TR3, and the fourth transistor TR4 may be turned off. In addition, the timing controller 300 may be configured to turn on the first transistor TR1 and the second transistor TR2 by generating and providing the first control signal CS1 and the second control signal CS2 having the active level.

Accordingly, an inductor current IL1 flowing through the inductor L may flow from the first node N1 toward the first output terminal T1. For example, the inductor current IL1 may be generated based on a voltage charged in the inductor L, and the first output voltage OV1 may be provided to the external device based on the inductor current IL1. The inductor L may be discharged as the inductor current IL1 decreases. The distribution circuit 100a may be configured to generate the first output voltage OV1, based on the voltage charged in the inductor L, and provide the first output voltage OV1 to the external device. In other words, energy charged in the inductor L may be provided to the external device through the first output terminal T1.

FIG. 3C illustrates an operation of the distribution circuit 100a to provide the second output voltage OV2 to the external device based on the charged inductor L. The timing controller 300 may be configured to generate and provide the switch control signal SCS, the first control signal CS1, and the second control signal CS2 having the inactive level to generate the second output voltage OV2 based on the charged inductor L. Accordingly, the switch SW, the first transistor TR1, and the second transistor TR2 may be turned off. In addition, the timing controller 300) may be configured to turn on the third transistor TR3 and the fourth transistor TR4 by generating and providing the third control signal CS3 and the fourth control signal CS4 having the active level.

Accordingly, an inductor current IL2 flowing through the inductor L may flow from the first node N1 toward the second output terminal T2. For example, the inductor current IL2 may be generated based on the voltage charged in the inductor L, and the second output voltage OV2 may be provided to the external device based on the inductor current IL2. The inductor L may be discharged as the inductor current IL2 decreases. The distribution circuit 100a may be configured to generate the second output voltage OV2, based on the voltage charged in the inductor L, and provide the second output voltage OV2 to the external device. In other words, energy charged in the inductor L may be provided to the external device through the second output terminal T2.

According to an embodiment of the disclosure, the aforementioned operation of the distribution circuit 100a with reference to FIG. 3A may be referred to as an operation to charge the inductor L, and the operations of the distribution circuit 100a with reference to FIGS. 3B and 3C may be referred to as an operation to discharge the voltage charged in the inductor L and an operation to generate the output voltage based on the charged inductor L. The distribution circuit 100a according to an embodiment of the disclosure may be configured to generate the first output voltage OV1 and the second output voltage OV2 corresponding to voltages inverted from the input voltage IV, based on the input voltage IV. In an example case in which the input voltage IV includes a positive voltage, the first output voltage OV1 and the second output voltage OV2 may include negative voltages. Voltage levels of the first output voltage OV1 and the second output voltage OV2 may be determined according to the turned-on times and the turned-off times of the first transistor TR1, the second transistor TR2, the third transistor TR3, and the fourth transistor TR4.

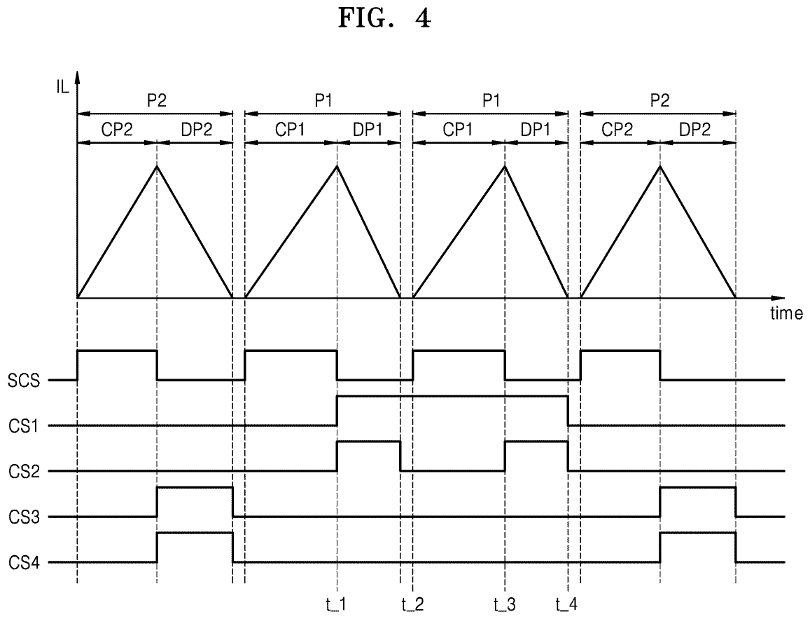

According to an embodiment, in order to provide voltage levels required for the external device, the timing controller 300 may be configured to generate control signals such that the distribution circuit 100a repeatedly provides each of the first output voltage OV1 and the second output voltage OV2 to the external device. For example, referring to FIG. 4 described below, the timing controller 300 may be configured to provide each of the first output voltage OV1 and the second output voltage OV2 twice to the external device. The timing controller 300 may be configured to generate the control signal such that the first output voltage OV1 and the second output voltage OV2 are alternately provided to the external device.

The distribution circuit 100a may be configured to perform the operation to generate the output voltages (e.g., the operation of the distribution circuit 100a with reference to FIG. 3B or 3C) based on the operation to charge the inductor L (e.g., the operation of the distribution circuit 100a with reference to FIG. 3A). Further details will be described below with reference to FIG. 4.

FIG. 4 is a timing chart of the control signals and the inductor current according to an embodiment.

FIG. 4 is the timing chart according to the descriptions with reference to FIGS. 3A, 3B, and 3C. Accordingly, FIG. 4 may be understood with reference to FIGS. 3A, 3B, and 3C, and same descriptions will not be repeatedly given.

Referring to FIGS. 1, 2 and 4, the distribution circuit 100a may repeat each of a first period P1 and a second period P2 twice. Hereinafter, the descriptions will be made under premise that the first period P1 refers to a period in which the distribution circuit 100a provides the first output voltage OV1 through the first output terminal T1 and the second period P2 refers to a period in which the distribution circuit 100a provides the second output voltage OV2 through the second output terminal T2. However, this is only for convenience of explanation and the disclosure is not limited thereto. For example, the distribution circuit 100a may be configured to provide the second output voltage OV2 to the external device through the second output terminal T2 in the first period P1, and may be configured to provide the first output voltage OV1 to the external device through the first output terminal T1 in the second period P2.

The timing controller 300 according to an embodiment of the disclosure may be configured to perform a plurality of the first periods P1 and a plurality of the second periods P2. Referring to FIG. 4, each of the first period P1 and the second period P2 may be performed twice. However, the disclosure is not limited thereto, and the number of repetition of the first period P1 and/or the second period P2 may vary according to the voltage level required by the external device.

The first period P1 may include a first charge period CP1 and a first discharge period DP1. The first charge period CP1 may refer to a period in which the inductor is charged. Levels of the switch control signal SCS, the first control signal CS1, the second control signal CS2, the third control signal CS3, and the fourth control signal CS4 in the first charge period CP1 may be understood based on the descriptions with reference to FIG. 3A. The first discharge period DP1 may refer to a period in which the charged inductor is discharged. For example, the first discharge period DP1 may refer to a period in which the first output voltage OV1 is generated based on the charged inductor. Levels of the switch control signal SCS, the first control signal CS1, the second control signal CS2, the third control signal CS3, and the fourth control signal CS4 in the first discharge period DP1 may be understood based on the descriptions with reference to FIG. 3B. Referring to FIGS. 1 and 4, as described above, the distribution circuit 100a may generate the output voltages based on the inductor charged in each of the first period P1 and the second period P2, and thus, the discharge period may be performed after the charge period.

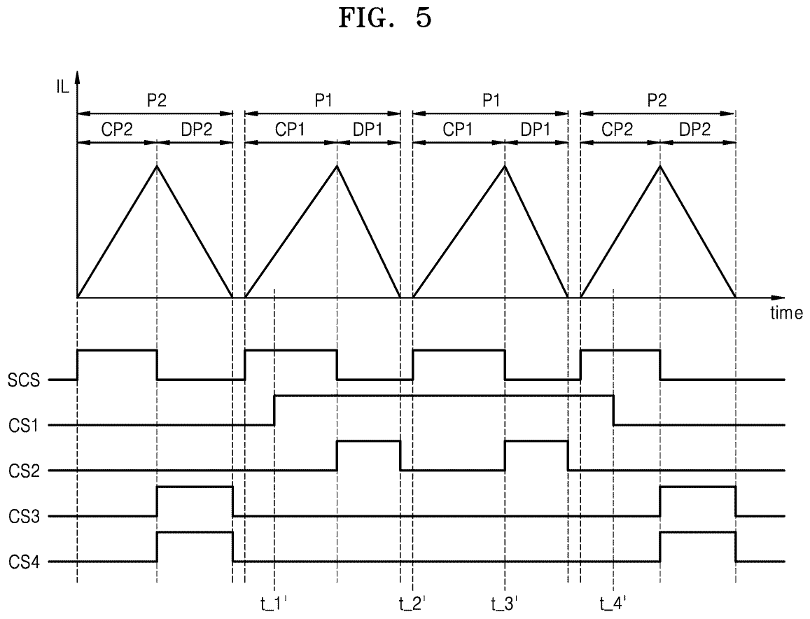

However, referring to FIG. 4, the first period P1 may be consecutively repeated twice between two second periods P2. As the first periods P1 are consecutive, the distribution circuit 100a may be configured to generate the first control signal CS1 having the active level during the first charge period CP1 in the first discharge period DP1, (for example, from a t_2 time point to a t_3 time point). Accordingly, the distribution circuit 100a may be configured to generate the first control signal CS1 having the active level from a t_1 time point to a t_4 time point. Accordingly, the first transistor TR1 may maintain a turned-on state from the t_1 time point to the t_4 time point. In other words, the timing controller 300 may be configured to generate a control signal such that the first transistor TR1 maintains the turned-on state from the first discharge period DP1 included in the first period P1 being first in sequence of at least two consecutive first periods P1 to the first discharge period DP1 included in the first period P1 being last in sequence of the at least two consecutive first periods P1. However, the disclosure is not limited thereto, and the timing controller 300 may be configured to generate a control signal such that the first transistor TR1 maintains the turned-on state from a certain time point of the first charge period CP1 included in the first period P1 being the first in sequence of the at least two first periods P1. Descriptions thereof will be made below with reference to FIG. 5.

Unlike in FIG. 5, in an example case in which the two first periods P1 and the two second periods P2 are alternately performed, the first transistor TR1 has to be in the turned-off state while the second period P2 is performed, and therefore, the first transistor TR1 has to be switched more times than when the first periods P1 are consecutively repeated. Accordingly, the distribution circuit 100a according to an embodiment of the disclosure may maintain the first transistor in the turned-on state without switching by consecutively repeating the first period P1. Accordingly, energy consumption for switching may be reduced, and energy efficiency of the distribution circuit 100a may increase. In addition, by maintaining the first transistor TR1 in the turned-on state, a residual current, which remains in the distribution circuit 100a after the first discharge period DP1, may be removed.

The second period P2 may include a second charge period CP2 and a second discharge period DP2. The second charge period CP2 may refer to a period in which the inductor is charged. Levels of the switch control signal SCS, the first control signal CS1, the second control signal CS2, the third control signal CS3, and the fourth control signal CS4 in the second charge period CP2 may be understood based on the descriptions with reference to FIG. 3A. The second discharge period DP2 may refer to a period in which the charge inductor is discharged. For example, the second discharge period DP2 may refer to a period in which the second output voltage OV2 is generated based on the charged inductor. Levels of the switch control signal SCS, the first control signal CS1, the second control signal CS2, the third control signal CS3, and the fourth control signal CS4 in the second discharge period DP2 may be understood based on the descriptions with reference to FIG. 3C.

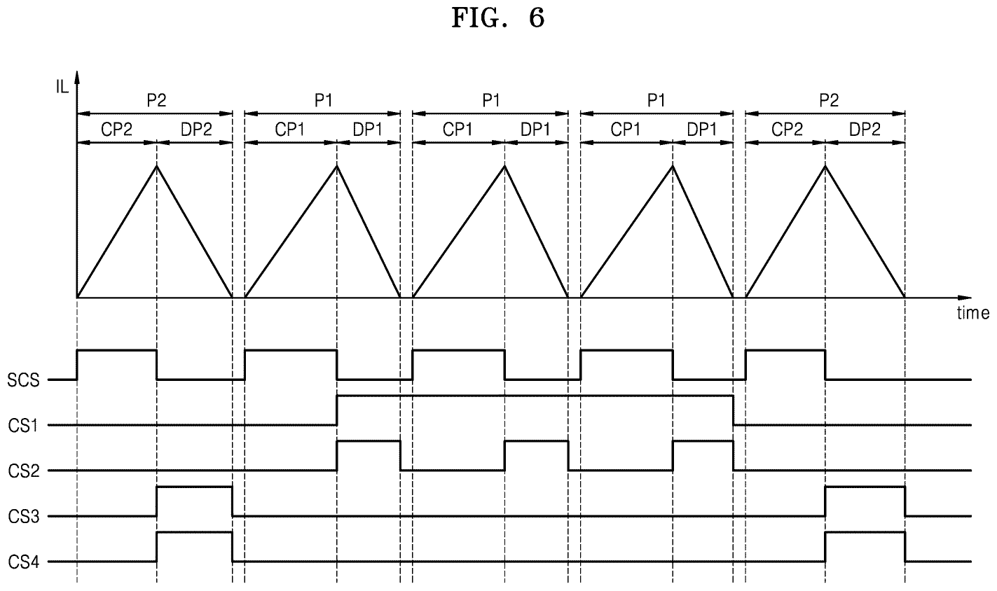

Although consecutive repetition of the first periods P1 is described with reference to FIG. 4, this is only an example, and the distribution circuit 100a according to an embodiment of the disclosure may consecutively repeat the second periods P2 between the first periods P1 repeated. In this case, like in the description written above, the number of times of switching of the third transistor TR3 decreases, and therefore, the energy efficiency of the distribution circuit 100a may increase. Likewise, although consecutive repetition of the first periods P1 is described with reference to FIGS. 5 and 6 described below, the distribution circuit 100a according to an embodiment of the disclosure may consecutively repeat the second periods P2 between the first periods P1 repeated.

According to an embodiment, the control signals may be generated such that the plurality of first periods P1 are consecutive and the plurality of second periods P2 are consecutive. In this case, similar to the descriptions above, the number of times of switching of the first transistor TR1 and the third transistor TR3 decreases, and therefore, the energy efficiency of the distribution circuit 100a) may increase.

Referring to the descriptions above, the distribution circuit 100a according to an embodiment of the disclosure may be configured to repeatedly perform the plurality of first periods P1 and the plurality of second periods P2 and alternately provide the first output voltage OV1 and the second output voltage OV2 to the external device. The distribution circuit 100a may be configured to generate the control signals such that the plurality of first periods P1 and/or the plurality of second periods P2 are consecutive.

FIG. 5 is a timing chart of the control signals and the inductor current according to an embodiment.

FIG. 5 is a timing chart according to the descriptions with reference to FIGS. 3A, 3B, and 3C. Accordingly, FIG. 5 may be understood with reference to FIGS. 3A, 3B, and 3C, and same descriptions will not be repeatedly given.

Referring to FIGS. 4 and 5, a period in which the first control signal CS1 having the active level is applied is different, and other control signals (the switch control signal SCS, the second control signal CS2, the third control signal CS3, and the fourth control signal CS4) may be uniformly applied.

Referring to FIG. 5, like in FIG. 4, two first periods P1 may be consecutive between two second periods P2, and the first control signal CS1 having the active level for the first charge period CP1 between two first discharge periods DP1, (for example, from a t_2′ time point to a t_3′ time point), may be generated. However, unlike in FIG. 4, the distribution circuit 100a may be configured to generate the first control signal CS1 having the active level from a t_1′ time point to a t_4′ time point. Accordingly, the first transistor TR1 may maintain the turned-on state from the t_1′ time point to the t_4′ time point. As illustrated in FIG. 5, the timing controller 300 may be configured to generate the control signals and provide the control signals to the distribution circuit 100a, such that the first transistor TR1 is turned on in the first charge period CP1 included in the first period P1 being the first in sequence of the plurality of first periods P1 consecutively performed and the first transistor TR1 is turned off in the second charge period CP2 included in the second period P2 performed next to the first period P1 in the last turn of the plurality of first periods P1.

The timing controller 300 according to an embodiment of the disclosure may be configured to generate and provide the first control signal CS1 such that the first transistor TR1 is turned on from the first charge period CP1 included in the first period P1 being the first in sequence of the plurality of first periods P1 consecutively repeated to the first discharge period DP1 included in the first period P1 of the last turn of the plurality of first periods P1. However, even in this case, a period in which the first transistor TR1 maintains the turned-on state may not include at least a portion of the second discharge period DP2 included in the second period P2.

In an example case in which the first transistor TR1 is in the turned-on state, the third transistor TR3 may be in the turned-off state. In an example case in which the third transistor TR3 is in the turned-on state, the first transistor TR1 may be in the turned-off state. For example, unlike illustrated in FIG. 5, the timing controller 300 may be configured to provide the third control signal CS3, which has the active level to the t_1′ time point, to the third transistor TR3. In addition, the timing controller 300 may be configured to provide the third control signal CS3, which has the active level from the t_4′ time point, to the third transistor TR3. Accordingly, according to an example embodiment, a time point at which the first transistor TR1 is shifted may be identical to a time point at which the third transistor TR3 is shifted. The timing controller 300 according to an embodiment of the disclosure may be configured to provide the first control signal CS1 and the third control signal CS3 respectively to the first transistor TR1 and the third transistor TR3 such that the time point at which the first transistor TR1 is shifted is identical to the time point at which the third transistor TR3 is shifted.

Although it is described that the first periods P1 are consecutive with reference to FIG. 5, the disclosure is not limited thereto. For example, unlike the embodiment illustrated in FIG. 5, the distribution circuit 100a according to an embodiment of the disclosure may be configured to consecutively perform the plurality of second periods P2 between the first periods P1 repeatedly performed. In this case, similar to the description above, a time period in which the third transistor TR3 maintains the turned-on state may include a period from the second discharge period DP2 included in the second period P2 being the first in sequence of the plurality of second periods P2 consecutively performed to the second discharge period DP2 included in the second period P2 of the last turn of the plurality of second periods P2 consecutively performed, and may not include at least a portion of the first discharge period DP1 included in the first period P1.

FIG. 6 is a timing chart of the control signals and the inductor current according to an embodiment.

FIG. 6 is a timing chart based on the descriptions with reference to FIGS. 3A, 3B, and 3C. Accordingly, FIG. 6 may be understood with reference to FIGS. 3A, 3B, 3C, 4, and 5, and same descriptions will not be repeatedly given.

Referring to FIG. 6, the first period P1 may be consecutively performed three times between two second periods P2, unlike illustrated in FIGS. 4 and 5. As described above with reference to FIG. 5, a time period in which the first control signal CS1 maintains logic-high may include the period from the first discharge period DP1 included in the first period P1 being the first in sequence of the three first periods P1 consecutively performed to the first discharge period DP1 included in the first period P1 of the last turn of the three first periods P1, and may not include at least a portion of the second discharge period DP2 included in the second period P2.

Referring to FIG. 6, three first periods P1 are consecutively repeated, unlike in FIGS. 4 and 5. However, with reference to all of FIGS. 4 to 6, a level of the first control signal CS1 is shifted twice. Accordingly, when the number of times of the first period P1 being consecutively repeated is greater, there is relatively significant reduction in an amount of energy consumption for switching. Accordingly, when the first periods Pl are consecutively repeated, energy efficiency may be high.

Referring to FIGS. 4 to 6, the timing controller 300 may be configured to provide the control signals to the distribution circuit 100 such that the plurality of first periods P1 are consecutively repeated. As illustrated in FIG. 2, the distribution circuit 100 may include the first transistor TR1 and the second transistor TR2. The timing controller 300 may be configured to provide the control signal such that the first transistor TR1 is shifted only once from the turned-off state to the turned-on state during at least two first periods P1 being consecutively repeated.

FIG. 7 is a block diagram of a distribution circuit 100b according to an embodiment.

FIG. 7 illustrates the distribution circuit 100b in which a plurality of transistors are added to the distribution circuit 100a illustrated in FIG. 2. For example, the plurality of transistors may include, but is not limited to, a 2M-1th transistor TR2M-1 and a 2Mth transistor TR2M. Accordingly, FIG. 7 may be understood based on the description above with reference to FIG. 2.

The distribution circuit 100b may include M output terminals T1 to TM, and may be configured to provide M output voltages OV1 to OVM to the external device respectively through the M output terminals. Here, M is a natural number of three or greater. Referring to the description above, the timing controller 300 (see FIG. 1) may

be configured to repeat each of the first period to the Mth period to generate and provide a control signal such that the distribution circuit 100b generates the M output voltage OV1 to OVM and provides the M output voltages OV1 to OVM to the external device. The timing controller 300 may be configured to increase energy efficiency by providing the control signal such that each of the first period to the Mth period is consecutively performed.

In addition, the distribution circuit 100b may be configured to prevent short-through between an Mth output terminal TM and another output terminal by including the 2M-1th transistor TR2M-1 connected between the first node N1 and the Mth output terminal TM.

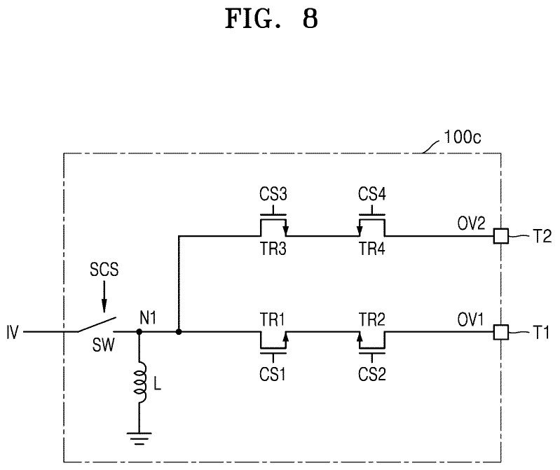

FIG. 8 is a block diagram of a distribution circuit 100c according to an embodiment.

FIG. 8 will be described with reference to FIG. 2.

Referring to FIG. 2, the distribution circuit 100a may include the first transistor TR1, the second transistor TR2, the third transistor TR3, and the fourth transistor TR4. A drain terminal of the first transistor TR1 may be connected to a drain terminal of the second transistor TR2, and a drain terminal of the third transistor TR3 may be connected to a drain terminal of the fourth transistor TR4.

Referring to FIG. 8, the distribution circuit may include the first transistor TR1, the second transistor TR2, the third transistor TR3, and the fourth transistor TR4. A source terminal of the first transistor TR1 may be connected to a source terminal of the second transistor TR2, and a source terminal of the third transistor TR3 may be connected to a source terminal of the fourth transistor TR4.

Referring to FIGS. 2 and 8, two transistors connected in series and included in the distribution circuit according to an embodiment of the disclosure may be connected source-to-source or drain-to-drain, to thereby prevent aforementioned short-through. This is based on consideration of directions of parasitic diodes respectively formed in the two transistors. Accordingly, in an example case in which two transistors are connected by a source of any one transistor and a drain of another transistor, parasitic diodes are formed in the two transistors. Thus, even when the two transistors are in a turned-off state, a current may flow through the parasitic diodes formed by the two transistors, and accordingly, short-through may occur.

Referring to FIGS. 2 to 8, it is described that the first transistor TR1, the second transistor TR2, the third transistor TR3, and the fourth transistor TR4 of the distribution circuit 100a include NMOS transistors, but the disclosure is not limited thereto. For example, two PMOS transistors may be in connection by sources or by drains in consideration of parasitic diodes, and NMOS transistors and PMOS transistors may be connected in series. However, the disclosure is not limited thereto, and as such, according to another embodiment, the distribution circuit may include a combination of the elements described above. For example, between the inductor and the first output terminal, two NMOS transistors may be in connection through sources or drains, and between the inductor and the second output terminal, two NMOS transistors may be in connection through drains or sources.

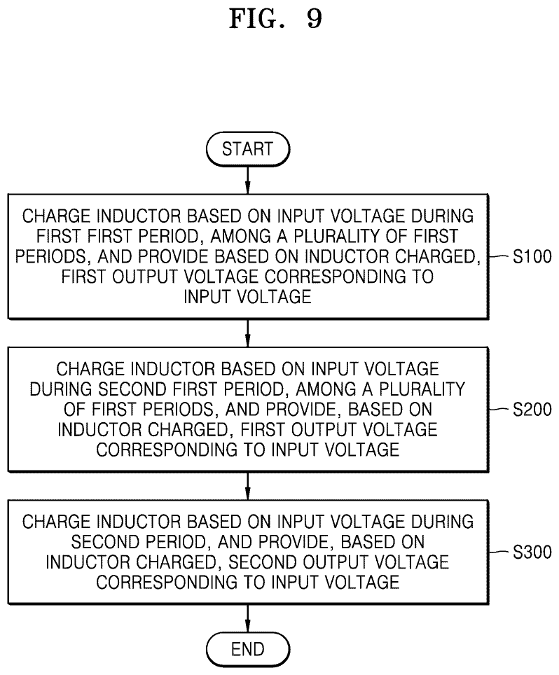

FIG. 9 is a flowchart illustrating operations of an electronic device including a distribution circuit according to an embodiment. According to an embodiment, during a plurality of first periods, the distribution circuit the electronic device 10 (see FIG. 1) may charge the inductor based on an input voltage and output, based on the inductor charged during the plurality of first periods, a first output voltage corresponding to the input voltage to outside through the first output terminal, and during a plurality of second periods, the distribution circuit the electronic device 10 may charge the inductor based on the input voltage, and output, based on the inductor charged during the plurality of second periods, a second output voltage corresponding to the input voltage to the outside through the second output terminal.

Referring to FIG. 9, in operation S100, during a first first period being the first in sequence, among the plurality of first periods, the electronic device 10 (see FIG. 1) may charge the inductor based on the input voltage, and based on the inductor charged during the first first period, the electronic device 10 may output the first output voltage corresponding to the input voltage to outside through the first output terminal. The first first period may include a first first charge period to charge the inductor and a first first discharge period to provide the first output voltage to the outside.

In operation S200, during a second first period being second in sequence that is consecutive to the first period, among the plurality of first periods,, the electronic device 10 may charge the inductor based on the input voltage, and based on the inductor charged during the second first period, the electronic device may output the first output voltage corresponding to the input voltage to the outside through the first output terminal. Accordingly, as described above, the first first period being the first in sequence and the second first period being the second in sequence are consecutive, and therefore, energy consumption for switching of the transistor may be reduced.

In operation S300, during a second period, the electronic device 10 may charge the inductor based on the input voltage, and based on the inductor charged during the second period, the electronic device 10 may provide the second output voltage corresponding to the input voltage to the outside through the second output terminal. The second period may include a second charge period to charge the inductor and a second discharge period to provide the second output voltage to the outside.

Referring to the description above, in embodiments according to the disclosure, the first transistor connected between the inductor and the first output terminal may be in the turned-on state during at least one of the first charge periods of the at least two first periods consecutively repeated. In addition, referring to the description with reference to FIGS. 5 and 6, the first transistor may be in the turned-on state during the first charge period included in each of the at least two first periods consecutively repeated. Furthermore, the first transistor may be in the turned-on state during at least a portion of the first charge period included in the first period being the first in sequence. In addition, the first transistor may be in the turned-on state during at least a portion of the second charge period included in the second period performed next to the first period of the last turn of the at least two first periods.

The first output voltage and the second output voltage according to the disclosure may correspond to voltages inverted from the input voltage.

Referring to the descriptions, the distribution circuit 100 (see FIG. 1) may further include a second transistor connected between the first output terminal and the first transistor, and the distribution circuit 100 (see FIG. 1) may prevent short-through by including two transistors connected in series.

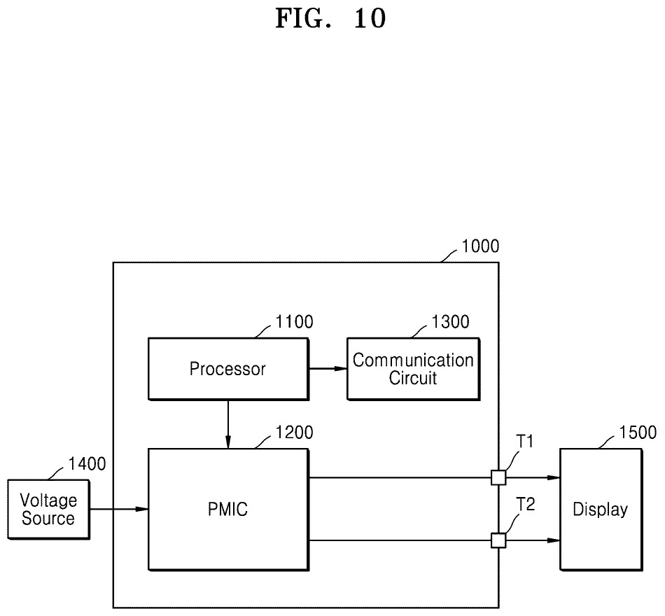

FIG. 10 is a block diagram of an electronic device 1000 according to an embodiment.

Referring to FIG. 10, the electronic device 1000 may include a processor 1100, a power management integrated circuit (PMIC, hereinafter referred to as PMIC) 1200, and a communication circuit 1300. A voltage source 1400 may correspond to the voltage source 200 (see FIG. 1) and a display 1500 may correspond to the ED 20 (see FIG. 1), and therefore may be understood as same components. Therefore, same descriptions will not be repeatedly given.

The processor 1100 may control general operations of the electronic device 1000. The processor 1100 may include a micro control unit (MCU). However, the processor 1100 is not limited thereto and may also include processors such as a central processing unit (CPU). The processor 1100 according to the disclosure may provide a control signal to the PMIC 1200 to perform the operation of the distribution circuit 100 (see FIG. 1) described above.

The PMIC 1200 may include the distribution circuit 100 (see FIG. 1) and the like according to the embodiments described above. The PMIC 1200 may be configured to provide an output voltage to the display 1500 by using the voltage source 1400.

While the inventive concept has been particularly shown and described with reference to embodiments thereof, it will be understood that various changes in form and details may be made therein without departing from the spirit and scope of the following claims.

What is claimed is:

1. An electronic device comprising:
an inductor configured to be charged based on an input voltage provided from a voltage source;
a distribution circuit configured to:
charge the inductor during a plurality of first periods, and provide a first output voltage based on the input voltage, to outside through a first output terminal, based on the inductor that is charged, and
charge the inductor during a plurality of second periods, and provide a second output voltage based on the input voltage, to the outside through a second output terminal, based on the inductor that is charged; and
a timing controller configured to:
alternately provide the first output voltage and the second output voltage in the plurality of first periods and the plurality of second periods, and
provide a control signal to the distribution circuit such that at least some of the plurality of first periods are consecutive,
wherein the distribution circuit comprises a first transistor and a second transistor, and
wherein a first terminal of the first transistor is connected to the inductor, a second terminal of the first transistor is connected to a first terminal of the second transistor, and a second terminal of the second transistor is connected to the first output terminal.

2. The electronic device of claim 1, wherein the timing controller is configured to provide the control signal to the distribution circuit such that the at least some of the plurality of first periods are consecutive between two of the plurality of second periods.

3. The electronic device of claim 1, wherein the input voltage comprises a positive voltage, and the first output voltage and the second output voltage comprise negative voltages.

4. The electronic device of claim 1, wherein the second terminal of the first transistor corresponds to a drain of the first transistor, and the first terminal of the second transistor corresponds to a drain of the second transistor.

5. The electronic device of claim 1, wherein the second terminal of the first transistor corresponds to a source of the first transistor, and the first terminal of the second transistor corresponds to a source of the second transistor.

6. The electronic device of claim 1, wherein the first transistor and the second transistor comprise N-type metal-oxide-semiconductor (NMOS) transistors.

7. The electronic device of claim 1, wherein
the distribution circuit further comprises:
a third transistor and a fourth transistor,
wherein a first terminal of the third transistor is connected to the inductor, a second terminal of the third transistor is connected to a first terminal of the fourth transistor, and a second terminal of the fourth transistor is connected to a second output terminal.

8. The electronic device of claim 7, wherein,
based the first transistor being in a turned-on state, the third transistor is in a turned-off state, and
based on the third transistor being in the turned-on state, the first transistor is in the turned-off state.

9. The electronic device of claim 1, further comprising:
a switch connected between the inductor and the voltage source,
wherein each of the plurality of first periods comprises a first charge period to charge the inductor and a first discharge period to provide the first output voltage to outside through the first output terminal, and
wherein each of the plurality of second periods comprises a second charge period to charge the inductor and a second discharge period to provide the second output voltage to the outside through the second output terminal.

10. The electronic device of claim 9, wherein
the timing controller is further configured to provide the control signal such that the first transistor maintains a turned-on state from a first discharge period included in a first first period being a first in sequence, among the plurality of first periods, to a first discharge period included in a second first period being last in sequence, among the plurality first periods.

11. The electronic device of claim 10, wherein
the timing controller is configured to provide the control signal such that the first transistor is turned on in a first charge period included in the first first period being the first in sequence and the first transistor is turned off in a second charge period included in a second period, among the plurality of second periods, performed next after the second first period being the last in sequence.

12. An operating method of an electronic device, the method comprising:
charging an inductor, based on an input voltage provided from a voltage source, during a first first period being first in sequence among a plurality of first periods, and providing, based on the inductor charged during the first first period, a first output voltage corresponding to the input voltage to outside through a first output terminal;
charging the inductor, based on the input voltage, for a second first period being second in sequence consecutive to the first first period among a plurality of first periods, and providing, based on the inductor charged during the second first period, the first output voltage corresponding to the input voltage to the outside through the first output terminal;
charging the inductor, based on the input voltage, for a second period and providing, based on the inductor charged during the second period, a second output voltage corresponding to the input voltage to the outside through a second output terminal,
wherein each of the plurality of first periods comprises a first charge period to charge the inductor and a first discharge period to provide the first output voltage to the outside, and
wherein a first transistor is in a turned-on state from a first first discharge period of the first first period to a second first discharge period of the second first period, a first terminal of the first transistor is connected to the inductor, a second terminal of the first transistor is connected to a first terminal of a second transistor, and a second terminal of a second transistor is connected to the first output terminal.

13. The method of claim 12, wherein
the second period comprises a second charge period to charge the inductor and a second discharge period to provide the second output voltage to the outside, the second transistor is in a turned-on state in the second discharge period and is in a turned-off state in the second charge period.

14. The method of claim 12, wherein the first output voltage and the second output voltage correspond to voltages inverted from the input voltage.

15. The method of claim 12, wherein
a first terminal of a third transistor of the electronic device is connected to the inductor, a second terminal of the third transistor is connected to a first terminal of a fourth transistor of the electronic device, and a second terminal of the fourth transistor is connected to the second output terminal,
the second terminal of the first transistor and the first terminal of the second transistor correspond to a source or a drain, and the second terminal of the third transistor and the first terminal of the fourth transistor correspond to a source or a drain.

16. The method of claim 12, wherein the first transistor is in the turned-on state in at least a portion of a first charge period included in the first first period being the first in sequence.

17. The method of claim 16, wherein the first transistor is in the turned-on state in at least a portion of a second charge period included in the second period performed next after the second first period being the second in sequence.

18. An electronic device comprising:
an inductor configured to be charged based on an input voltage provided from a voltage source;
a distribution circuit configured to:
charge the inductor during a plurality of first periods, and provide a first output voltage based on the input voltage, to outside through a first output terminal, based on the inductor that is charged, and
charge the inductor during a plurality of second periods, and provide a second output voltage based on the input voltage, to the outside through a second output terminal, based on the inductor that is charged; and
a timing controller configured to provide a control signal to the distribution circuit such that plurality of first periods and the plurality of second periods are repeated and the first output voltage and the second output voltage are repeatedly provided in a time-division manner,
wherein the distribution circuit comprises:
a first transistor and a second transistor, which are connected in series between the inductor and the first output terminal, and a third transistor and a fourth transistor connected in series between the inductor and the second output terminal.

19. The electronic device of claim 18, wherein the timing controller is configured to provide a control signal to the distribution circuit such that at least two first periods, among the plurality of first periods, are consecutively repeated.

20. The electronic device of claim 19, wherein
the first transistor is connected between the inductor and the second transistor, the second transistor is connected between the first transistor and the first output terminal, and
the timing controller is configured to provide the control signal such that the first transistor is shifted only once from a turned-off state to a turned-on state during the at least two first periods consecutively repeated.
